(19) United States
(12) Patent Application Publication
(10) Pub. No.: US 2026/0048997 A1
(43) Pub. Date: Feb. 19, 2026

(54) METHOD FOR FLUORINE SEPARATION AND RECOVERY FROM PHOSPHATE ROCK ENHANCED WITH MICROBUBBLE COUPLED SILICON ADDITIVE

(71) Applicant: Institute of process Engineering Chinese Academy of Sciences, Beijing (CN)

(72) Inventors: Huiquan LI, Beijing (CN); Ganyu ZHU, Beijing (CN); Ziheng MENG, Beijing (CN); Kun YAN, Beijing (CN); Wenjuan ZHANG, Beijing (CN)

(73) Assignee: Institute of Process Engineering Chinese Academy of Sciences, Beijing (CN)

(21) Appl. No.: 19/300,196

(22) Filed: Aug. 14, 2025

(30) Foreign Application Priority Data
Aug. 14, 2024 (CN) 202411114166.6

(51) Int. Cl. C01F 11/46; C01B 7/19; C01B 33/107

(52) U.S. Cl. CPC C01F 11/46; C01B 7/191; C01B 33/10705

(57) ABSTRACT

The present application provides a method for fluorine separation and recovery from phosphate rock enhanced with a microbubble coupled silicon additive, which includes: mixing the phosphate rock, phosphoric acid, and an active silicon additive, and subjecting the mixture to reaction to obtain a slurry; subjecting the slurry to microbubble generation treatment to obtain a microbubble slurry, and subjecting the microbubble slurry to recycling and returning to the reaction, where a released volatile fluoride is recovered; and after completing the reaction, a defluorinated slurry is obtained; and subjecting the obtained defluorinated slurry to acid-decomposition reaction and then solid-liquid separation to obtain phosphoric acid and phosphogypsum. In the method provided by the present application, a synergistic effect of microbubbles and the active silicon additive is used in the phosphoric acid acid-decomposition of phosphate rock, enhancing the fluorine impurities in phosphate rock to convert into volatile fluoride SiF4 and HF, achieving the highly efficient separation and recovery of fluorine, and a recovery rate of fluorine reaches 43.9% or more; moreover, the fluorine impurities are separated from the source in the acid decomposition of phosphate rock, thereby preventing fluorine from entering the subsequent wet phosphoric acid process.

### CROSS-REFERENCE TO RELATED APPLICATION

This application claims priority to Chinese Patent Application No. 202411114166.6, filed on Aug. 14, 2024, the contents of which are incorporated herein in its entirety by reference.

### TECHNICAL FIELD

The present application belongs to the technical field of wet-process phosphoric acid, relates to a method for fluorine recovery from phosphate rock, and specifically relates to a method for fluorine recovery from phosphate rock enhanced with a microbubble coupled silicon additive.

### BACKGROUND

The wet process for phosphoric acid is a method of producing phosphoric acid by decomposing phosphate rock with inorganic acids. The main steps of the wet process for phosphoric acid production include: phosphate rock and an acid (including sulfuric acid, nitric acid, and hydrochloric acid, etc.) are subjected to acid decomposition, and the slurry after acid decomposition reaction is filtered to obtain gypsum filter cake and phosphoric acid with a low concentration, then the phosphoric acid with a low concentration is concentrated to produce phosphoric acid products. The acid decomposition process of phosphate rock actually is performed in two steps: the first step is the pre-decomposition treatment of the phosphate rock, where the phosphate rock is initially dissolved in phosphoric acid to form calcium dihydrogen phosphate; the second step involves reacting the calcium dihydrogen phosphate slurry obtained from the first step with excess sulfuric acid to produce a phosphoric acid solution with calcium sulfate crystals.

With the development of phosphate rock resources, the resource utilization of medium-and low-grade phosphate rock has become an urgent need in the phosphorus chemical industry. In the wet process for phosphoric acid using medium-and low-grade collophanite, the collophanite undergoes acid decomposition reaction with an acid, continuously releasing a large number of impurities such as aluminum, iron, magnesium, sodium, and potassium, which easily combine with fluorine to form fluorosilicates or fluoroaluminates. As the reaction continues, fluorosilicates and fluoroaluminates reach a supersaturated state and are prone to precipitate and crystallize, causing waste of fluorine resources, and also leading to excessive fluorine content in phosphogypsum. Therefore, the removal and recovery of fluorine during the acid decomposition process of phosphate rock is of significant importance.

CN115285954A discloses a method to improve the fluorine recovery rate in the concentration stage of wet-process for phosphoric acid production, which involves adding a defluorination agent emulsion to the dilute phosphoric acid produced by the process of wet-process for phosphoric acid, and then concentrating the solution to recover fluosilicic acid; CN105236372A discloses a method and an apparat for removing fluorine from wet-process phosphoric acid using a blowing method, which involves adding diatomaceous earth to fluorine-containing wet-process phosphoric acid and introducing hot air into the resulted mixture; fluorine in the fluorine-containing wet-process phosphoric acid is released in gaseous form under the action of hot air and diatomaceous earth. The existing defluorination processes usually target the wet-process phosphoric acid obtained to perform fluorine removal, and cannot solve the problem of fluorine impurities from the source in the process of wet-process for phosphoric acid, and the entrainment of phosphogypsum products also leads to a high fluorine content.

CN115611248A discloses a method for phosphate rock decomposition enhanced with microbubbles, which involves treating a sulfuric acid acid-decomposition solution with microbubbles to enhance the decomposition of phosphate rock particles and the release of fluorine-containing gases. However, this method can only strengthens the release of existing fluorine-containing gases and is difficult to achieve the further transformation of other fluorine-containing substances, which is hard to further improve the removal and recovery effectiveness of fluorine.

Therefore, based on the shortcomings of the existing art, a method for enhancing fluorine conversion and recovery during the acid-decomposition process of phosphate rock needs to be provided.

### SUMMARY

An object of the present application is to provide a method for fluorine separation and recovery from phosphate rock enhanced with a microbubble coupled silicon additive, which could enhance the conversion of fluorine to a volatile fluoride for separation and recovery during the phosphoric acid acid-decomposition process of phosphate rock.

To achieve the above purpose, the present application adopts the following technical solution.

The present application provides a method for fluorine separation and recovery from phosphate rock enhanced with a microbubble coupled silicon additive, and the method includes the following steps:
(1) mixing the phosphate rock, phosphoric acid, and an active silicon additive, and subjecting the mixture to reaction to obtain a slurry; the slurry is subjected to microbubble generation treatment to obtain a microbubble slurry, and subjecting the microbubble slurry to recycling and returning to the reaction, where a released volatile fluoride is recovered; and after completing the reaction, a defluorinated slurry is obtained; and
(2) subjecting the defluorinated slurry obtained from step (1) to acid-decomposition reaction and then solid-liquid separation to obtain phosphoric acid and phosphogypsum.

The preparation of phosphoric acid through the acid-decomposition reaction of phosphate rock simultaneously produces phosphogypsum, which is performed in two processes: one is the reaction process between phosphate rock and phosphoric acid (also known as pre-mixing or pre-treatment), and the second is the acid-decomposition reaction process between the phosphoric acid reaction slurry and sulfuric acid. In the phosphoric acid reaction process, phosphate rock reacts with phosphoric acid to produce calcium dihydrogen phosphate and releases hydrofluoric acid. The reaction equation is as follows:

Due to the relatively weak acidity of phosphoric acid, impurity minerals in phosphate rock (such as quartz, calcium feldspar, potassium feldspar, sodium feldspar, pyrite) are difficult to react with phosphoric acid, thereby the release amounts of impurities such as silicon, aluminum, sodium, potassium, and iron are small, while fluorine mainly exists in the form of hydrofluoric acid. In the process of sulfuric acid acid-decomposition reaction, sulfuric acid continues to react with calcium dihydrogen phosphate in the phosphoric acid reaction slurry to produce phosphoric acid and phosphogypsum. The reaction equation is as follows:

Due to the strong acidity of sulfuric acid, the undecomposed impurity minerals during the phosphoric acid acid-decomposition process continue to react with sulfuric acid, releasing a large amount of impurities such as silicon, aluminum, iron, magnesium, sodium, and potassium, which are easily combined with fluorine to generate a fluorosilicate or a fluoroaluminate. The reaction process is as follows:

As the reaction continues, the fluosilicate and fluoroaluminate reach a supersaturated state, are prone to precipitate and crystallize, and dope into the phosphogypsum during the vacuum filtration process. In the phosphoric acid obtained through filtration, fluorine mainly exists in the form of the fluosilicate, fluoroaluminate, and a small amount of hydrofluoric acid, which leads to a waste of fluorine resources, and also results in an excessively high residual fluorine content in the phosphogypsum.

In the phosphoric acid reaction process, silicon-containing impurity minerals in phosphate rock (such as calcium feldspar, potassium feldspar, sodium feldspar, and quartz) have weak reactivity and are difficult to react with hydrofluoric acid. In the present application, by introducing the active silicon additive (i.e., active silicates, including soluble silicates, some colloidal silica, and oligomeric silicates) during the phosphoric acid reaction process, the rapid reaction between hydrofluoric acid in the acid solution and the active silicon additive (generally expressed in the form of SiO2) can be directly enhanced to generate fluosilicic acid. The reaction equation is as follows:

The strong shearing force generated during the production of microbubbles, as well as the instantaneous release of pressure when microbubbles collapse, can create ultra-high-speed micro-jets and localized ultra-high temperature and ultra-high pressure, which can, on one hand, enhance the particle breakage of the active silicon additive, promote the reaction dissociation of phosphate rock and the decomposition and release of fluorine, reduce the particle size of the active silicon additive particles, increase the reaction area, and accelerate the reaction between hydrogen fluoride and the active silicon additive; on the other hand, under the effects of high temperature, strong acidity, and localized ultra-high temperature/high pressure and micro-jets generated by the collapse of microbubbles, fluorosilicic acid is extremely prone to decompose into highly volatile silicon tetrafluoride and hydrogen fluoride. The reaction equation is as follows:

The mass transfer rate of the gas inside the microbubble is extremely fast, which can quickly “bring” the above-mentioned highly volatile fluorine-containing compounds out of the liquid surface (i.e., gas stripping), achieving the separation of fluorine.

Preferably, the composition of the phosphate rock includes: P2O5 15-35 wt %, F 1.5-4 wt %, SiO2 5-15 wt %, Al2O3 1-8 wt %, Fe2O3 0.1-2 wt %, K2O 0.1-3 wt %, and Na2O 0.05-1.5 wt %.

In the phosphate rock, a content of P2O5 is 15-35 wt %, which may be, for example, 15 wt %, 18 wt %, 20 wt %, 22 wt %, 25 wt %, 28 wt %, 30 wt %, 32 wt %, or 35 wt %, but is not limited to the listed values, and other unlisted values within the numerical range are also applicable.

In the phosphate rock, a content of F is 1.5-4.0 wt %, which may be, for example, 1.5 wt %, 2.0 wt %, 2.5 wt %, 3.0 wt %, 3.5 wt %, or 4.0 wt %, but is not limited to the listed values, and other unlisted values within the numerical range are also applicable.

In the phosphate rock, a content of SiO2 is 5-15 wt %, which may be, for example, 5 wt %, 6 wt %, 7 wt %, 8 wt %, 9 wt %, 10 wt %, 11 wt %, 12 wt %, 13 wt %, 14 wt %, or 15 wt %, but is not limited to the listed values, and other unlisted values within the numerical range are also applicable.

In the phosphate rock, a content of Al2O3 is 1-8 wt %, which may be, for example, 1 wt %, 2 wt %, 3 wt %, 4 wt %, 5 wt %, 6 wt %, 7 wt %, or 8 wt %, but is not limited to the listed values, and other unlisted values within the numerical range are also applicable.

In the phosphate rock, a content of Fe2O3 is 0.1-2 wt %, which may be, for example, 0.1 wt %, 0.3 wt %, 0.5 wt %, 0.8 wt %, 1 wt %, 1.2 wt %, 1.5 wt %, 1.8 wt %, or 2 wt %, but is not limited to the listed values, and other unlisted values within the numerical range are also applicable.

In the phosphate rock, a content of K2O is 0.1-3 wt %, which may be, for example, 0.1 wt %, 0.5 wt %, 1 wt %, 1.5 wt %, 2 wt %, 2.5 wt %, or 3 wt %, but is not limited to the listed values, and other unlisted values within the numerical range are also applicable.

In the phosphate rock, a content of Na2O is 0.05-1.5 wt %, which may be, for example, 0.05 wt %, 0.1 wt %, 0.3 wt %, 0.5 wt %, 0.8 wt %, 1.0 wt %, 1.2 wt %, or 1.5 wt %, but is not limited to the listed values, and other unlisted values within the numerical range are also applicable.

Preferably, a content of P2O5 in the phosphoric acid is 35-55%, which may be, for example, 35%, 38%, 40%, 42%, 45%, 48%, 50%, 52%, or 55%, but is not limited to the listed values, and other unlisted values within the numerical range are also applicable.

Preferably, a mass ratio of the phosphate rock to the phosphoric acid is 1:(1-2), which may be, for example, 1:1, 1:1.1, 1:1.2, 1:1.3, 1:1.4, 1:1.5, 1:1.6, 1:1.7, 1:1.8, 1:1.9 or 1:2, but is not limited to the listed values, and other unlisted values within the numerical range are also applicable.

Preferably, the active silicon additive includes any one of or a combination of at least two of diatomaceous earth, white carbon black, silica fume, silica aerogel, or nano-silica. Typical but non-limiting combinations include a combination of diatomaceous earth and white carbon black, a combination of white carbon black and silica fume, a combination of silica fume and silica aerogel, a combination of silica aerogel and nano-silica, a combination of diatomaceous earth, white carbon black, and silica fume, a combination of silica fume, silica aerogel, and nano-silica, a combination of diatomaceous earth, white carbon black, silica fume, and silica aerogel, or a combination of diatomaceous earth, white carbon black, silica fume, silica aerogel, and nano-silica.

Preferably, a mass ratio of silicon in the active silicon additive to fluorine in the phosphate rock is (0.5-3):1, which may be, for example, 0.5:1, 1:1, 1.5:1, 2:1, 2.5:1, or 3:1, but is not limited to the listed values, and other unlisted values within the numerical range are also applicable.

Preferably, the reaction is performed at a temperature of 95-115° C., which may be, for example, 95° C., 98° C., 100° C., 102° C., 105° C., 108° C., 110° C., 112° C., or 115° C., but is not limited to the listed values, and other unlisted values within the numerical range are also applicable.

Preferably, the reaction is performed for a period of 1-5 h, which may be, for example, 1 h, 2 h, 3 h, 4 h, or 5 h, but is not limited to the listed values, and other unlisted values within the numerical range are also applicable.

Preferably, a gas-liquid volume ratio of the microbubble generation treatment is 1:(5-10), which may be, for example, 1:5, 1:6, 1:7, 1:8, 1:9, or 1:10, but is not limited to the listed values, and other unlisted values within the numerical range are also applicable.

Preferably, a gas used in the microbubble generation treatment includes any one of or a combination of at least two of air, N2, O2, or CO2. Typical but non-limiting combinations include a combination of air and N2, a combination of N2 and O2, a combination of O2 and CO2, a combination of air, N2, and O2, a combination of N2, O2, and CO2, or a combination of air, N2, O2, and CO2.

Preferably, an average diameter of the microbubbles is 300-800 μm, which may be, for example, 300 μm, 350 μm, 400 μm, 450 μm, 500 μm, 550 μm, 600 μm, 650 μm, 700 μm, 750 μm, or 800 μm, but is not limited to the listed values, and other unlisted values within the numerical range are also applicable.

In the present application, the microbubble treatment adopts the slurry as the water source, the gas as the gas source, and is performed by introducing both the water source and the gas source into a microbubble generating device, respectively; the used microbubble generating device can be a conventional microbubble generating device in the art, and the specific structure of the microbubble generating device is not limited herein by the present application.

Preferably, a fluorine content in the volatile fluoride is 1-12 kg/m3, which may be, for example, 1 kg/m3, 2 kg/m3, 4 kg/m3, 5 kg/m3, 6 kg/m3, 8 kg/m3, 10 kg/m3, or 12 kg/m3, but is not limited to the listed values, and other unlisted values within the numerical range are also applicable.

Preferably, during the subjecting the microbubble slurry to recycling and returning process, a mass flow rate ratio of the microbubble slurry to the phosphoric acid is (20-40):1, which may be, for example, 20:1, 22:1, 25:1, 28:1, 30:1, 32:1, 35:1, 38:1, or 40:1, but is not limited to the listed values, and other unlisted values within the numerical range are also applicable.

Preferably, the acid-decomposition reaction includes a reaction between the defluorinated slurry and the sulfuric acid.

Preferably, the acid-decomposition reaction is performed at a temperature of 80-105° C., which may be, for example, 80° C., 85° C., 90° C., 95° C., 100° C., or 105, but is not limited to the listed values, and other unlisted values within the numerical range are also applicable.

Preferably, a mass ratio of the sulfuric acid to the phosphate rock is (0.6-1.4):1, which may be, for example, 0.6:1, 0.7:1, 0.8:1, 0.9:1, 1.0:1, 1.1:1, 1.2:1, 1.3:1, or 1.4:1, but is not limited to the listed values, and other unlisted values within the numerical range are also applicable.

Preferably, in the slurry obtained by the acid-decomposition reaction, process water is used to control the content of P2O5 in the slurry to 25-40%, which may be, for example, 25%, 28%, 30%, 32%, 35%, 38%, or 40%, but is not limited to the listed values, and other unlisted values within the numerical range are also applicable.

As a preferred technical solution of the method provided by the present application, the method includes the following steps:
(1) mixing the phosphate rock, the phosphoric acid, and the active silicon additive, and subjecting the mixture to a reaction at 95-115° C.; wherein, in the phosphate rock, a content of P2O5 is 15-35 wt %, a content of F is 1.5-4 wt %, a content of SiO2 is 5-15 wt %, a content of Al2O3 is 1-8 wt %, a content of Fe2O3 is 0.1-2 wt %, a content of K2O is 0.1-3 wt %, and a content of Na2O is 0.05-1.5 wt %; a content of P2O5 in the phosphoric acid is 35-55%, a mass ratio of the phosphate rock to the phosphoric acid is 1:(1-2), and a mass ratio of silicon in the active silicon additive to fluorine in the phosphate rock is (0.5-3):1; thus obtaining a slurry;
subjecting the slurry to microbubble generation treatment; during the microbubble generation treatment, the gas-liquid volume ratio is 1:(5-10), and the average diameter of the microbubbles is 300-800 μm; thus, obtaining a microbubble slurry;
subjecting the microbubble slurry to recycling and returning to the reaction, where a flow rate ratio of the microbubble slurry to the phosphoric acid is (20-40):1; simultaneously, a volatile fluoride is released, where a fluorine content in the volatile fluoride is 1-12 kg/m3; and absorbing the volatile fluoride by spraying an aqueous solution;
performing the reaction for 1-5 h; after the reaction is completed, the defluorinated slurry is obtained; and
(2) subjecting the defluorinated slurry and sulfuric acid to acid-decomposition reaction at 80-105° C., where a mass ratio of the sulfuric acid to the phosphate rock is (0.6-1.4):1; after the acid-decomposition reaction, a slurry is obtained; controlling the content of P2O5 in the slurry to 25-40% by adding process water, then subjecting the slurry to solid-liquid separation to obtain the phosphoric acid and the phosphogypsum, and returning part of the phosphoric acid to the reaction in step (1).

Compared with the prior art, the present application has the following beneficial effects.

In the method provided by the present application, a synergistic effect of microbubbles and the active silicon additive is used in the phosphoric acid acid-decomposition of phosphate rock, enhancing the fluorine impurities in phosphate rock to convert into volatile fluoride SiF4 and HF, achieving the highly efficient separation and recovery of fluorine, and a recovery rate of fluorine reaches 43.9% or more; moreover, the fluorine impurities are separated from the source in the acid decomposition of phosphate rock, thereby preventing fluorine from entering the subsequent wet phosphoric acid process.

### BRIEF DESCRIPTION OF DRAWINGS

FIG. 1 is a flowchart of the method for fluorine separation and recovery from phosphate rock enhanced with a microbubble coupled silicon additive provided by Example 1.

### DETAILED DESCRIPTION

The technical solution of the present application is further illustrated by the following embodiments. It should be clear to those skilled in the art that the embodiments are merely used for a better understanding of the present application and should not be regarded as a specific limitation to the present application.

### Example 1

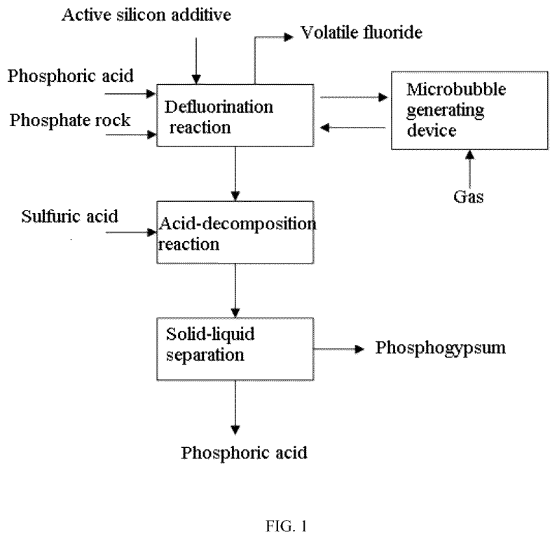

This example provides a method for fluorine separation and recovery from phosphate rock enhanced with a microbubble coupled silicon additive as shown in FIG. 1.

The composition of phosphate rock includes: P2O5 29 wt %, F 2.8 wt %, SiO2 10 wt %, Al2O3 5 wt %, Fe2O3 1 wt %, K2O 0.5 wt %, and Na2O 0.9 wt %.

The method includes the following steps:
(1) phosphate rock, phosphoric acid with a P2O5 content of 45%, and an active silicon additive (diatomaceous earth) were mixed and subjected to a reaction; wherein, a mass ratio of phosphate rock to phosphoric acid was 1:1.8, a mass ratio of diatomaceous earth and phosphate rock equivalent to the mass of silicon to the mass of fluorine was 1.5:1, and the reaction was performed at 110° C.;
(2) the slurry formed in step (1) was adopted as a water source, air was adopted as a gas source, and the gas source and the water source were introduced into a microbubble generating device in a volume ratio of 1:7, respectively, then microbubbles were formed in the slurry with an average diameter of 500 μm; the microbubble-containing slurry was subjected to recycling and returning to the reaction in step (1), where a mass flow rate ratio of the microbubble-containing slurry to phosphoric acid was 30:1; simultaneously, a volatile fluoride with a fluorine content of 8 kg/m3 was released and then absorbed by spraying of an aqueous solution; the reaction was performed for 3 h, after the reaction was completed, a defluorinated slurry was obtained; and
(3) the defluorinated slurry obtained from step (2) and sulfuric acid were subjected to acid-decomposition reaction, where a mass ratio of sulfuric acid (with a concentration of 98%) to phosphate rock was 1.1:1, the P2O5 content in the slurry was controlled to 28% by adding process water, and the acid-decomposition reaction was performed at 85° C.; after the acid-decomposition reaction, the slurry was filtered to obtain phosphoric acid and phosphogypsum, and part of the phosphoric acid according to the usage amount was returned to the reaction in step (1).

### Example 2

This example provides a method for fluorine separation and recovery from phosphate rock enhanced with a microbubble coupled silicon additive.

The composition of phosphate rock includes: P2O5 15 wt %, F 1.5 wt %, SiO2 15 wt %, Al2O3 8 wt %, Fe2O3 2 wt %, K2O 3 wt %, and Na2O 0.05 wt %.

The method includes the following steps:
(1) phosphate rock, phosphoric acid with a P2O5 content of 35%, and an active silicon additive (50% nano-silica and 50% silica aerogels) were mixed and subjected to a reaction; wherein, a mass ratio of phosphate rock to phosphoric acid was 1:1, a mass ratio of the active silicon additive and phosphate rock equivalent to the mass of silicon to the mass of fluorine was 3:1, and the reaction was performed at 115° C.;
(2) the slurry formed in step (1) was adopted as a water source, nitrogen was adopted as a gas source, and the gas source and the water source were introduced into a microbubble generating device in a volume ratio of 1:5, respectively, then microbubbles were formed in the slurry with an average diameter of 800 μm; the microbubble-containing slurry was subjected to recycling and returning to the reaction in step (1), where a mass flow rate ratio of the microbubble-containing slurry to phosphoric acid was 40:1; simultaneously, a volatile fluoride with a fluorine content of 1 kg/m3 was released and then absorbed by spraying of an aqueous solution; the reaction was performed for 5 h, after the reaction was completed, a defluorinated slurry was obtained; and
(3) the defluorinated slurry obtained from step (2) and sulfuric acid (with a concentration of 98%) were subjected to acid-decomposition reaction, where a mass ratio of sulfuric acid to phosphate rock was 0.6:1, the P2O5 content in the slurry was controlled to 25% by adding process water, and the acid-decomposition reaction was performed at 80° C.; after the acid-decomposition reaction, the slurry was filtered to obtain phosphoric acid and phosphogypsum, and part of the phosphoric acid according to the usage amount was returned to the reaction in step (1).

### Example 3

This example provides a method for fluorine separation and recovery from phosphate rock enhanced with a microbubble coupled silicon additive.

The composition of phosphate rock includes: P2O5 35 wt %, F 4 wt %, SiO2 5 wt %, Al2O3 1 wt %, Fe2O3 0.1 wt %, K2O 0.1 wt %, and Na2O 1.5 wt %.

The method includes the following steps:
(1) phosphate rock, phosphoric acid with a P2O5 content of 55%, and an active silicon additive (70% white carbon black and 30% silica fume) were mixed and subjected to a reaction; wherein, a mass ratio of phosphate rock to phosphoric acid was 1:2, a mass ratio of the active silicon additive and phosphate rock equivalent to the mass of silicon to the mass of fluorine was 0.5:1, and the reaction was performed at 95° C.;
(2) the slurry formed in step (1) was adopted as a water source, 50% O2 and 50% CO2 were adopted as a gas source, and the gas source and the water source were introduced into a microbubble generating device in a volume ratio of 1:10, respectively, then microbubbles were formed in the slurry with an average diameter of 300 μm; the microbubble-containing slurry was subjected to recycling and returning to the reaction in step (1), where a mass flow rate ratio of the microbubble-containing slurry to phosphoric acid was 20:1; simultaneously, a volatile fluoride with a fluorine content of 12 kg/m3 was released and then absorbed by spraying of an aqueous solution; the reaction was performed for 1 h, after the reaction was completed, a defluorinated slurry was obtained; and
(3) the defluorinated slurry obtained from step (2) and sulfuric acid (with a concentration of 98%) were subjected to acid-decomposition reaction, where a mass ratio of sulfuric acid to phosphate rock was 1.4:1, the P2O5 content in the slurry was controlled to 40% by adding process water, and the acid-decomposition reaction was performed at 105° C.; after the acid-decomposition reaction, the slurry was filtered to obtain phosphoric acid and phosphogypsum, and part of the phosphoric acid according to the usage amount was returned to the reaction in step (1).

### Example 4

This example provides a method for fluorine separation and recovery from phosphate rock enhanced with a microbubble coupled silicon additive. Compared with Example 1, the temperature of the reaction in step (1) was controlled at 85° C., and others were the same as those in Example 1.

### Example 5

This example provides a method for fluorine separation and recovery from phosphate rock enhanced with a microbubble coupled silicon additive. Compared with Example 1, the temperature of the reaction in step (1) was controlled at 125° C., and others were the same as those in Example 1.

### Example 6

This example provides a method for fluorine separation and recovery from phosphate rock enhanced with a microbubble coupled silicon additive. Compared with Example 1, the P2O5 content of phosphoric acid in step (1) was controlled at 25%, and others were the same as those in Example 1.

### Example 7

This example provides a method for fluorine separation and recovery from phosphate rock enhanced with a microbubble coupled silicon additive. Compared with Example 1, the P2O5 content of phosphoric acid in step (1) was controlled at 65%, and others were the same as those in Example 1.

### Comparative Example 1

This comparative example provides a method for fluorine separation and recovery from phosphate rock enhanced with microbubbles.

The phosphate rock used was the same as that in Example 1.

The method includes the following steps:
(1) phosphate rock and phosphoric acid with a P2O5 content of 45% were mixed and subjected to a reaction; wherein, a mass ratio of phosphate rock to phosphoric acid was 1:1.8, and the reaction was performed at 110° C. for 3 h; after the reaction was completed, a slurry was obtained; and
(2) the slurry obtained from step (1) and sulfuric acid were mixed and subjected to acid-decomposition reaction, where a mass ratio of sulfuric acid to phosphate rock was 1.1:1, the P2O5 content in the slurry was controlled to 28% by adding process water, and the acid-decomposition reaction was performed at 85° C.; the slurry obtained after the acid-decomposition reaction was adopted as a water source, air was adopted as a gas source, and the gas source and the water source were introduced into a microbubble generating device in a volume ratio of 1:7, respectively, then microbubbles were formed in the slurry with an average diameter of 500 μm; the microbubble-containing slurry was subjected to recycling and returning to the acid-decomposition reaction, where a mass flow rate ratio of the microbubble-containing slurry to phosphoric acid was 30:1; after the acid-decomposition reaction was completed, the slurry was filtered to obtain phosphoric acid and phosphogypsum.

That is, compared with Example 1, in the method, the active silicon additive was not added in step (1), the microbubble generation treatment was not performed in step (2), and a microbubble treatment was performed in the acid-decomposition reaction in step (3). Other conditions were the same as those in Example 1.

### Comparative Example 2

This comparative example provides a method for fluorine separation and recovery from phosphate rock enhanced with microbubbles.

The phosphate rock used was the same as that in Example 1.

The method includes the following steps:
(1) phosphate rock, phosphoric acid with a P2O5 content of 45%, and an active silicon additive (diatomaceous earth) were mixed and subjected to a reaction; wherein, a mass ratio of phosphate rock to phosphoric acid was 1:1.8, a mass ratio of diatomaceous earth and phosphate rock equivalent to the mass of silicon to the mass of fluorine was 1.5:1, and the reaction was performed at 110° C. for 3 h; after the reaction was completed, a slurry was obtained; and
(2) the slurry obtained from step (1) and sulfuric acid were mixed and subjected to acid-decomposition reaction, where a mass ratio of sulfuric acid to phosphate rock was 1.1:1, the P2O5 content in the slurry was controlled to 28% by adding process water, and the acid-decomposition reaction was performed at 85° C.; the slurry obtained after the acid-decomposition reaction was adopted as a water source, air was adopted as a gas source, and the gas source and the water source were introduced into a microbubble generating device in a volume ratio of 1:7, respectively, then microbubbles were formed in the slurry with an average diameter of 500 μm; the microbubble-containing slurry was subjected to recycling and returning to the acid-decomposition reaction, where a mass flow rate ratio of the microbubble-containing slurry to phosphoric acid was 30:1; after the acid-decomposition reaction was completed, the slurry was filtered to obtain phosphoric acid and phosphogypsum.

That is, compared with Example 1, in the method, the microbubble generation treatment was not performed in step (2), and a microbubble treatment was performed in the acid-decomposition reaction in step (3). Other conditions were the same as those in Example 1.

### Comparative Example 3

This comparative example provides a method for fluorine separation and recovery from phosphate rock enhanced with microbubbles.

The phosphate rock used was the same as that in Example 1.

The method includes the following steps:
(1) phosphate rock and phosphoric acid with a P2O5 content of 45% were mixed and subjected to a reaction; wherein, a mass ratio of phosphate rock to phosphoric acid was 1:1.8, and the reaction was performed at 110° C. for 3 h; after the reaction was completed, a slurry was obtained;
(2) the slurry obtained from step (1) and sulfuric acid were mixed and subjected to acid-decomposition reaction, where a mass ratio of sulfuric acid to phosphate rock was 1.1:1, the P2O5 content in the slurry was controlled to 28% by adding process water, and the acid-decomposition reaction was performed at 85° C.; after the acid-decomposition reaction was completed, the slurry was filtered to obtain phosphoric acid and phosphogypsum; and
(3) the phosphoric acid obtained by filtration in step (2) and an active silicon additive (diatomaceous earth) were mixed and subjected to a reaction, wherein a mass ratio of diatomaceous earth and phosphoric acid equivalent to the mass of silicon to the mass of fluorine was 1.5:1, and the reaction was performed at 110° C. for 3 h; phosphoric acid was adopted as a water source, air was adopted as a gas source, and the gas source and the water source were introduced into a microbubble generating device in a volume ratio of 1:7, respectively, then microbubbles were formed in the phosphoric acid with an average diameter of 500 μm; the microbubble-containing acid liquor was subjected to recycling and returning to the phosphoric acid, where a mass flow rate ratio of the microbubble-containing acid liquor to phosphoric acid was 30:1.

That is, compared with Example 1, in the method, the active silicon additive was not added in step (1), the microbubble generation treatment was not performed in step (2), and in the acid-decomposition reaction in step (3), an active silicon additive was added to the phosphoric acid obtained by filtration, and microbubble treatment was performed. Other conditions were the same as those in Example 1.

### Comparative Example 4

This comparative example provides a method for fluorine separation and recovery from phosphate rock enhanced with microbubbles. Compared with Example 1, the active silicon additive was not added in step (1), and others were the same as those in Example 1.

### Comparative Example 5

This comparative example provides a method for fluorine separation and recovery from phosphate rock enhanced with a silicon additive. Compared with Example 1, the microbubble generation treatment was not performed in step (2), and others were the same as those in Example 1.

### Comparative Example 6

This comparative example provides a method for fluorine separation and recovery from phosphate rock enhanced with bubbles. Compared with Example 1, the microbubble generating device was replaced with a bubbling device in step (2), that is, gas with an equal amount was used for bubbling with an average diameter of bubbles of 2 mm, and others were the same as those in Example 1.

### Comparative Example 7

This comparative example provides a method for fluorine separation and recovery from phosphate rock enhanced with gas stripping. Compared with Example 1, the microbubble generating device was replaced with a steam stripping device in step (2), that is, steam with an equal amount was adopted as a gas source for steam stripping with a steam pressure of 0.4 MPa, and others were the same as those in Example 1.

### Performance Characterization

The fluorine content of the phosphoric acid obtained from Examples and Comparative Examples and the fluorine content of the phosphogypsum obtained from Examples and Comparative Examples were determined, and the fluorine recovery rate was calculated. The results are listed in Table 1.

The fluorine content of phosphoric acid was determined according to GB/T 21057-2007 Inorganic chemical for industrial use-General method for determination of fluorine content-Ion selective electrode method.

The fluorine content of phosphate rock and phosphogypsum was tested by X-ray fluorescence spectrometry.

The calculation method for the fluorine recovery rate is as follows:

$$fluorine recovery rate = ( mass of phosphate rock \times fluorine content of phosphate rock - mass of phosphogypsum \times fluorine content of phosphogypsum - mass of phosphoric acid \times fluorine content of phosphoric acid ) / ( mass of phosphate rock \times fluorine content of phosphate rock ) \times 100 \%$$

TABLE 1

| | Fluorine recovery | Fluorine content in |
|---|---|---|
| | rate (%) | phosphogypsum (%) |
| Example 1 | 99.5 | Not detected |
| Example 2 | 98.8 | Not detected |
| Example 3 | 99.0 | Not detected |
| Example 4 | 68.8 | 1.13 |
| Example 5 | 71.6 | 1.02 |
| Example 6 | 55.2 | 1.22 |
| Example 7 | 43.9 | 1.36 |
| Comparative Example 1 | 76.4 | Not detected |
| Comparative Example 2 | 71.0 | 1.56 |
| Comparative Example 3 | 46.5 | 2.19 |
| Comparative Example 4 | 50.3 | 1.88 |
| Comparative Example 5 | 24.9 | 2.12 |
| Comparative Example 6 | 31.8 | 2.01 |
| Comparative Example 7 | 47.2 | 1.91 |

As can be seen from Table 1, the method of fluorine separation and recovery provided by the present application is aimed at the reaction process between phosphate rock and phosphoric acid, an active silicon additive coupled with microbubbles is used to enhance the defluorination, converting fluorine into volatile fluoride, achieving effective defluorination in the wet phosphoric acid process, improving fluorine recovery rate, and reducing fluorine entrainment in phosphogypsum products. In Examples 1-3, fluorine recovery rate reaches 98.8% or more, and no fluorine content is detected in phosphogypsum.

Compared with Example 1, in Example 4, the reaction temperature is overly low, and fluorosilicic acid is easier to decompose under high temperature and strong acid conditions, therefore, the rate of fluorosilicic acid decomposes into silicon tetrafluoride and hydrogen fluoride is slower, thus the fluorine recovery rate is reduced; in Example 5, the reaction temperature is overly high, resulting in a decrease in gas solubility, and microbubbles are difficult to maintain and easy to agglomerate, although the rate of fluorosilicic acid decomposes into silicon tetrafluoride and hydrogen fluoride is accelerated, the fluorine recovery rate is reduced due to the lack of microbubble gas to “bring out” the decomposition products; in Example 6, the acidity of the acid liquor is weak, and the rate of silicic acid decomposes into silicon tetrafluoride and hydrogen fluoride is slower, thus the fluorine recovery rate is reduced; in Example 7, the acidity of the acid liquor is too strong, and the impurity minerals (calcite feldspar, potassium feldspar, sodium feldspar, and pyrite, etc.) will release more impurities such as silicon, aluminum, potassium, sodium, ferrum, etc., which will convert the fluorosilicic acid into fluorosilicate and fluoroaluminate and form precipitation, leading to a reduced fluorine recovery rate and a high fluorine content of phosphogypsum.

In Comparative Example 1, the introduction of microbubble treatment in the acid-decomposition process by sulfuric acid has a certain defluorination effect, and the fluorine content is not detected in phosphogypsum, but the fluorine remains in the phosphoric acid product in the form of fluoroaluminate and fluorosilicate, which cannot be recovered by microbubbles, resulting in a decrease in the overall recovery rate of fluorine; in Comparative Example 2, an active silicon additive was added in the phosphoric acid reaction process to convert hydrofluoric acid into fluorosilicic acid, but no microbubble treatment was performed, and the fluoride cannot volatilize and escape, and then, a large amount of fluorosilicic acid is converted into fluorosilicate and fluoroaluminate, and the introduction of microbubbles in the acid-decomposition process by sulfuric acid cannot realize the decomposition and conversion of fluorine, resulting in a low fluorine recovery rate and a high fluorine content of phosphogypsum; in Comparative Example 3, an silicon additive was added to phosphoric acid and microbubbles were introduced, and the fluorine in phosphoric acid mainly exists in the form of fluorosilicate, fluoroaluminate, and a small amount of hydrofluoric acid, which are difficult to convert and decompose, resulting in a low fluorine recovery rate and a high fluorine content of phosphogypsum; in Comparative Example 4, only microbubble treatment was carried out, fluorine still exists in the form of hydrofluoric acid, and the boiling point of hydrofluoric acid is higher than that of silicon tetrafluoride, and the volatility of hydrofluoric acid is weaker than that of silicon tetrafluoride, thus fluorine cannot be brought out in a large amount; in Comparative Example 5, only an silicon additive were added, and fluorine is converted from hydrofluoric acid to fluorosilicic acid, but with the lack of microbubbles, the decomposition rate of fluorosilicic acid is low and difficult to volatilize, resulting in a low fluorine recovery; in Comparative Example 6, bubbling is used for defluorination, the gas mass transfer rate is slow, and the bubble exists for a short time in the liquid phase, thus the amount of gas entering the liquid phase is small, and the fluorine-containing gas cannot be quickly “brought out”, and the bubbles do not have the ability of microbubbles to decompose fluorosilicic acid, resulting in a low fluorine recovery; in Comparative Example 7, the use of steam stripping will lead to a decrease in the concentration of acid liquor due to steam condensation, thereby the rate of fluorosilicic acid decomposes into silicon tetrafluoride and hydrogen fluoride is low, resulting in a low fluorine recovery.

To sum up, in the method provided by the present application, a synergistic effect of microbubbles and the active silicon additive is used in the phosphoric acid acid-decomposition of phosphate rock, enhancing the fluorine impurities in phosphate rock to convert into volatile fluoride SiF4 and HF, achieving the highly efficient separation and recovery of fluorine, and a recovery rate of fluorine reaches 43.9% or more; moreover, the fluorine impurities are separated from the source in the acid decomposition of phosphate rock, thereby preventing fluorine from entering the subsequent wet phosphoric acid process.

The applicant declares that the above is only the specific embodiment of the present application, but the present application is not limited to the above examples. Those skilled in the art should understand that any changes or substitutions can be easily thought of by any skilled in the art within the technical scope disclosed in the present application shall fall within the protection scope and disclosure scope of the present application.

What is claimed is:

1. A method for fluorine separation and recovery from phosphate rock enhanced with a microbubble coupled silicon additive, which comprises the following steps:
(1) mixing the phosphate rock, phosphoric acid, and an active silicon additive, and subjecting the mixture to reaction to obtain a slurry; the slurry is subjected to microbubble generation treatment to obtain a microbubble slurry, and subjecting the microbubble slurry to recycling and returning to the reaction, where a released volatile fluoride is recovered; and after completing the reaction, a defluorinated slurry is obtained;
in the phosphoric acid, a content of P2O5 is 35-55 wt %;
the reaction is performed at a temperature of 95-115° C.;
a mass ratio of silicon in the active silicon additive to fluorine in the phosphate rock is (0.5-3):1;
a gas-liquid volume ratio of the microbubble generation treatment is 1:(5-10);
a gas used in the microbubble generation treatment comprises any one of or a combination of at least two of air, N2, O2, or CO2;
an average diameter of the microbubbles is 300-800 μm; and
(2) subjecting the defluorinated slurry obtained from step (1) to acid-decomposition reaction and then solid-liquid separation to obtain phosphoric acid and phosphogypsum.

2. The method according to claim 1, wherein the composition of the phosphate rock comprises:
P2O5 15-35 wt %, F 1.5-4 wt %, SiO2 5-15 wt %, Al2O3 1-8 wt %, Fe2O3 0.1-2 wt %, K2O 0.1-3 wt %, and Na2O 0.05-1.5 wt %.

3. The method according to claim 1, wherein a mass ratio of the phosphate rock to the phosphoric acid is 1:(1-2).

4. The method according to claim 1, wherein the active silicon additive comprises any one of or a combination of at least two of diatomaceous earth, white carbon black, silica fume, silica aerogel, or nano-silica.

5. The method according to claim 1, wherein the reaction in step (1) is performed for a period of 1-5 h.

6. The method according to claim 1, wherein during the subjecting the microbubble slurry to recycling and returning process, a mass flow rate ratio of the microbubble slurry to the phosphoric acid is (20-40):1.

7. The method according to claim 1, wherein the acid-decomposition reaction comprises a reaction between the defluorinated slurry and the sulfuric acid;
the acid-decomposition reaction is performed at a temperature of 80-105° C.;
a mass ratio of the sulfuric acid to the phosphate rock is (0.6-1.4):1;
in the slurry obtained by the acid-decomposition reaction, process water is used to control the content of P2O5 in the slurry to 25-40%.

8. The method according to claim 1, wherein the method comprises the following steps:
(1) mixing the phosphate rock, the phosphoric acid, and the active silicon additive, and subjecting the mixture to a reaction at 95-115° C.; wherein, in the phosphate rock, a content of P2O5 is 15-35 wt %, a content of F is 1.5-4 wt %, a content of SiO2 is 5-15 wt %, a content of Al2O3 is 1-8 wt %, a content of Fe2O3 is 0.1-2 wt %, a content of K2O is 0.1-3 wt %, and a content of Na2O is 0.05-1.5 wt %; a content of P2O5 in the phosphoric acid is 35-55%, a mass ratio of the phosphate rock to the phosphoric acid is 1:(1-2), and a mass ratio of silicon in the active silicon additive to fluorine in the phosphate rock is (0.5-3):1; thus obtaining a slurry;
subjecting the slurry to microbubble generation treatment; during the microbubble generation treatment, the gas-liquid volume ratio is 1:(5-10), and the average diameter of the microbubbles is 300-800 μm; thus, obtaining a microbubble slurry;
subjecting the microbubble slurry to recycling and returning to the reaction, where a flow rate ratio of the microbubble slurry to the phosphoric acid is (20-40):1; simultaneously, the volatile fluoride is released, where a fluorine content in the volatile fluoride is 1-12 kg/m3; and absorbing the volatile fluoride by spraying an aqueous solution;
performing the reaction for 1-5 h; after the reaction is completed, the defluorinated slurry is obtained; and
(2) subjecting the defluorinated slurry and sulfuric acid to acid-decomposition reaction at 80-105° C., where a mass ratio of the sulfuric acid to the phosphate rock is (0.6-1.4):1; after the acid-decomposition reaction, a slurry is obtained; controlling the content of P2O5 in the slurry to 25-40% by adding process water, then subjecting the slurry to solid-liquid separation to obtain the phosphoric acid and the phosphogypsum, and returning part of the phosphoric acid to the reaction in step (1).
